(19) United States
(12) Patent Application Publication
(10) Pub. No.: US 2008/0210694 A1
(43) Pub. Date: Sep. 4, 2008

(54) DRINKING VESSEL

(76) Inventor: Michel Castonguay, Ottawa (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/021,827

(22) Filed: Jan. 29, 2008

Related U.S. Application Data
(60) Provisional application No. 60/887,900, filed on Feb. 2, 2007.

(51) Int. Cl. A47J 41/00; B65D 23/00

(52) U.S. Cl. 220/592.17; 220/592.2; 215/12.1

(57) ABSTRACT

A drinking vessel has a hollow cylindrical shell dimensioned to enable a user to ergonomically grasp the drinking vessel and a beverage-containing cup mounted inside the hollow cylindrical shell, the cup and hollow cylindrical member defining an annular air gap to thermally insulate the beverage contained in the cup of the drinking vessel. This drinking vessel is stable, fits in cup-holders, for example at sports events, and provides an outer surface for displaying advertising or other information. The beverage-containing cup can be shaped, for example, like the cup portion of a wine glass, martini glass, champagne flute, shot glass, beer glass or other desired shapes.

### CROSS-REFERENCE TO RELATED APPLICATIONS

This application claims priority under 35 U.S.C. §119(e) from U.S. Provisional Patent Application 60/887,900 entitled DRINKING VESSEL filed Feb. 2, 2007.

### TECHNICAL FIELD

This application relates, in general, to drinking vessels and, more particularly, to the type of drinking vessels and stemware used for consuming alcoholic beverages.

### BACKGROUND OF THE INVENTION

Stemmed drinking vessels, such as wine glasses, martini glasses, and champagne flutes, have a circular base connected to a stem upon which is supported a beverage-containing cup. As is well known in the art, the stem enables the consumer of the beverage to hold the drinking vessel without transferring too much heat to the beverage in the cup.

Although these traditional, prior-art stemmed drinking vessels are ubiquitous, they do, however, suffer from a number of shortcomings. Firstly, stemmed drinking vessels are somewhat unstable because of the relatively high center of mass when a beverage is contained in the elevated cup portion. Secondly, these stemmed drinking glasses tend to be fragile due primarily to their long and slender stems, which are typically made of glass, crystal or plastic. Thirdly, because of their shape, traditional stemware cannot easily be held by a conventional cup-holder such as, for example, the sort of cup-holder typically found beside seats in sport arenas or stadiums. For example, when wine is sold at a sports event, the wine is typically served in a flimsy plastic cup, because traditional stemware would be too unstable when placed in a cup-holder. However, for many consumers of wine, the experience of drinking wine from a cup as opposed to a proper wine glass is unsatisfactory. Fourthly, unlike traditional plastic disposable cups, such as the sort used to serve beer at sports events, traditional stemware does not offer much space for placing advertising.

In view of the shortcomings of the prior art, therefore, an improved drinking vessel remains highly desirable.

### SUMMARY OF THE INVENTION

The present invention is a drinking vessel having an outer shell dimensioned to enable a user to ergonomically grasp the drinking vessel and a beverage-containing cup mounted inside the outer shell. The cup and the outer shell together define an annular air gap which thermally insulates the beverage contained in the cup from the heat of the user's hand.

Not only is this novel drinking vessel stable (unlike a traditional stemmed glass) when placed in a cup-holder, this drinking vessel is simple and inexpensive to manufacture (for example, by known molding or forming techniques). This novel drinking vessel provides the same the thermal and aromatic benefits of stemmed glasses, without the instability and fragility of stemmed glasses. Furthermore, the outer shell of this novel drinking vessel presents a large surface for displaying advertising or other information, which is particularly useful in the context of spectator sports where alcoholic (and non-alcoholic) beverages are typically consumed in cups bearing advertising. Furthermore, this novel drinking vessel can be used at wine festivals, and in bars, clubs and other venues.

In various embodiments, the cup of the drinking vessel can be shaped to mimic that of a wine glass, martini glass, champagne flute, shot glass, beer glass, etc. While a cylindrical outer shell represents the simplest embodiment to manufacture, the outer shell can be slightly flared or frusta-conical, or it could be composed of a cylindrical lower portion and a frusta-conical upper portion. The drinking vessel can be made of a plastic, e.g. by molding or forming the cup and shell as an integral, unitary drinking vessel. The resulting drinking vessel can be used as a disposable drinking glass for wine, martinis, champagne, shooters, beer or other beverages, including non-alcoholic ones. While it can be used in a variety of contexts and settings, such as bars, clubs, festivals, etc., this drinking vessel is particularly useful in sports arenas and stadiums where the outer shell serves as an advertising medium.

### BRIEF DESCRIPTION OF THE DRAWINGS

Further features and advantages of the present invention will become apparent from the following detailed description, taken in combination with the appended drawings, in which:

FIG. 1 is an isometric perspective view of a drinking vessel for wine in accordance with one embodiment of the present invention;

FIG. 2 is a side cross-sectional view of the drinking vessel of FIG. 1;

FIG. 3 is an isometric perspective view of a drinking vessel for champagne in accordance with a second embodiment of the present invention;

FIG. 4 is a side cross-sectional view of the drinking vessel of FIG. 3;

FIG. 5 is an isometric perspective view of a drinking vessel for a cocktail in accordance with a third embodiment of the present invention;

FIG. 6 is a side cross-sectional view of the drinking vessel of FIG. 4;

FIG. 7 is an isometric perspective view of a drinking vessel for shooters in accordance with a fourth embodiment of the present invention;

FIG. 8 is a side cross-sectional view of the drinking vessel of FIG. 6;

FIG. 9 is a isometric perspective view of a drinking vessel for beer in accordance with a fifth embodiment of the present invention;

FIG. 10 is a side cross-sectional view of the drinking vessel of FIG. 8;

FIG. 11 is a side cross-sectional view of a frusta-conical drinking vessel having air holes in accordance with a further embodiment of the present invention; and

FIG. 12 is a side cross-sectional view of a drinking vessel having a lower cylindrical portion and an upper frusta-conical portion in accordance with yet a further embodiment.

### DETAILED DESCRIPTION OF EMBODIMENTS

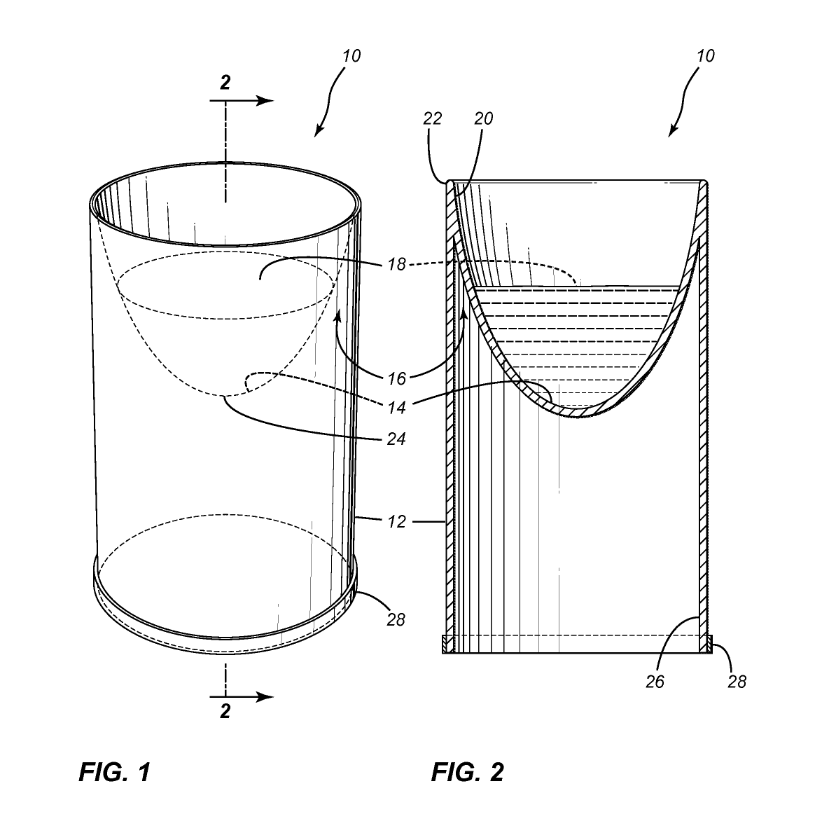

Various embodiments of the present invention are described, by way of example only, with reference to FIGS. 1 to 12.

FIGS. 1 and 2 depict a drinking vessel, generally designated by reference numeral 10, in accordance with a first embodiment of the present invention. The drinking vessel 10 has an outer shell 12 dimensioned to enable a user to ergonomically grasp the drinking vessel. In other words, the outer dimension of the outer shell is selected so that the vessel can be comfortably gripped in a single hand. The drinking vessel also includes a beverage-containing cup 14 mounted inside the outer shell. The cup 14 and the outer shell 12 together define an annular air gap 16 to thermally insulate the beverage 18 contained in the cup 14 of the drinking vessel 10. The annular air gap 16 ensures that heat from the user's hand does not unduly warm the beverage, thus functioning as the equivalent of a stem on a stemmed drinking glass. As will be described below, the shell can optionally include air holes to further augment the dissipation of heat.

In this embodiment, the beverage-containing cup 14 has a generally parabolic shape for containing wine or other beverages that are typically consumed in glasses having this (or similar) shape. This shape mimics a traditional, flared wine glass in terms of aromatics.

In this embodiment, the outer shell 12 is preferably cylindrical, i.e. a hollow cylinder or tube, although, as will be presented below, the outer shell 12 may be made to have other shapes as well. This cylindrical outer shell is stable and robust. Preferably, the outer shell is dimensioned to fit in a standard cup-holder so that the drinking vessel can be stably ensconced in a cup-holder at a sports stadium or arena (or in other contexts as well).

As shown in FIGS. 1 and 2, the outer shell present a large outer surface that is well adapted for the displaying of advertising and/or other information content, such as the names, logos, trademarks, symbols, etc. of beverage makers or other commercial entities. As is known in the art, a variety of methods can be used to place advertising on the outer shell, including glued paper labels, shrunk plastic labels, direct printing, embossing, etc. Not only can corporate logos and information be placed on this novel drinking vessel, but (due to the ease and low cost of manufacture), small production runs with customized logos, brands, emblems or information can be made for specific events, for example.

As shown in FIGS. 1 and 2, a top 20 of the beverage-containing cup 14 is aligned with an upper rim 22 of the outer shell 12. More preferably, the top 20 of the beverage-containing cup 14 is integrally formed with the upper rim 22 of the outer shell 12, as illustrated in FIG. 1. Preferably, the beverage-containing cup 14 has a bottom 24 that is substantially elevated relative to a bottom rim 26 of the outer shell 12.

The outer shell and the beverage-containing cup can be integrally formed by molding or forming techniques such as, for example, blow-molding, injection molding, rotomolding, thermoforming, or other known techniques. The drinking vessel is preferably made from plastic although glass or other materials such as wood or metal could also be used.

In terms of plastics, the drinking vessel can be made of Polyethylene Terephthalate (PET or PETE), High Density Polyethylene (HDPE), Vinyl (V), Low Density Polyethylene (LDPE), Polypropylene (PP), Polystyrene (PS), Polylactic Acid (PLA), Bioplastics, Bio-degradables or other thermoplastics.

The outer shell and cup are preferably made from a transparent plastic (to enable the consumer to view the beverage) although semi-transparent (colored) or opaque plastics could be used. By making the shell and beverage-containing cup translucent, the user is able to view the beverage contained in the cup, thus enhancing the overall drinking experience. The translucent drinking vessel can be made to be either purely transparent (i.e. clear plastic or glass) or semi-transparent (colored) by using a colored plastic or glass. In turn, the advertising or information placed on the outer shell can be opaque or semi-transparent (colored or frosted).

In a preferred embodiment, the outer shell and cup are molded to form a unitary disposable plastic drinking vessel upon which advertising or other information content can be optionally displayed.

Optionally, the bottom rim 26 has a metal ring 28 for surrounding and reinforcing the bottom rim 16. The metal ring can be made of aluminum and press-fit over the bottom rim of the shell. This ring enhances the sturdiness, stability and overall aesthetics of the vessel.

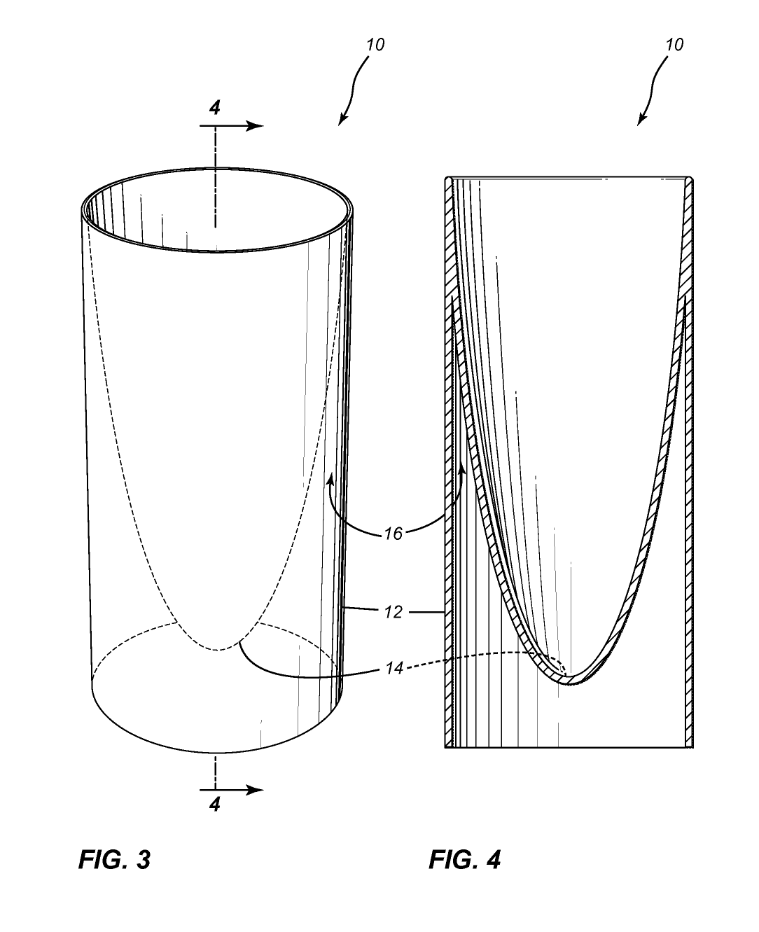

FIGS. 3 and 4 depict another embodiment of the drinking vessel 10 which has a fluted cup 14 that is shaped to contain champagne or bubbly wine. Again, an annular air gap 16 is provided between the cup and the shell to thermally isolate the beverage from the heat of the user's hand. By using a transparent or translucent outer shell (with translucent or semi-transparent advertising optionally displayed on the outer shell), the consumer of the sparkling wine or champagne can view the bubbles in the beverage, thus enhancing the overall experience.

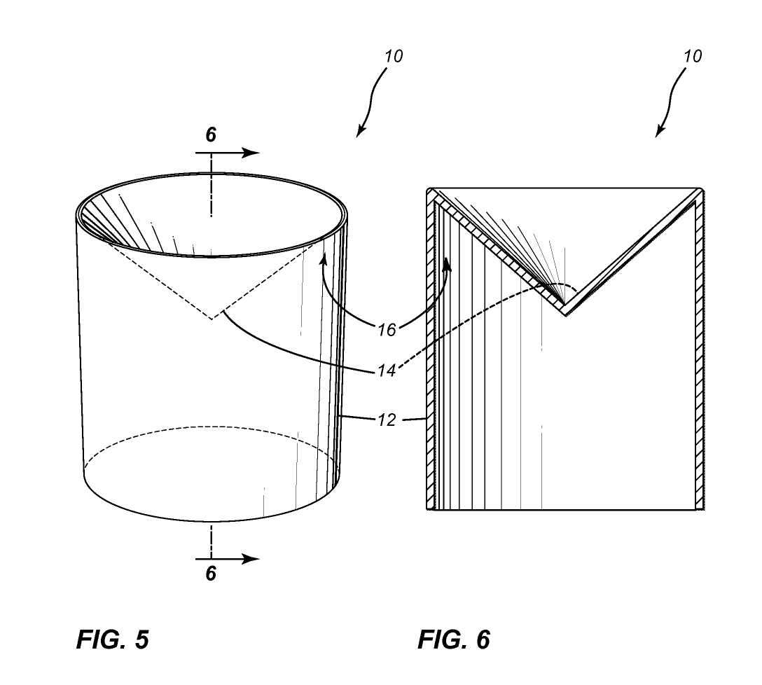

FIGS. 5 and 6 depict yet another embodiment of the drinking vessel 10 which has a V-shaped cup 14 for a martini or other cocktail. This V-shaped (i.e. conical) cup 14 can be made preferably to converge to a point like a true martini glass. By making the vessel transparent or translucent, the consumer can view the contents of the glass (including any ice or olives that may be added to the cocktail), thus making the overall experience of consuming the beverage more pleasurable.

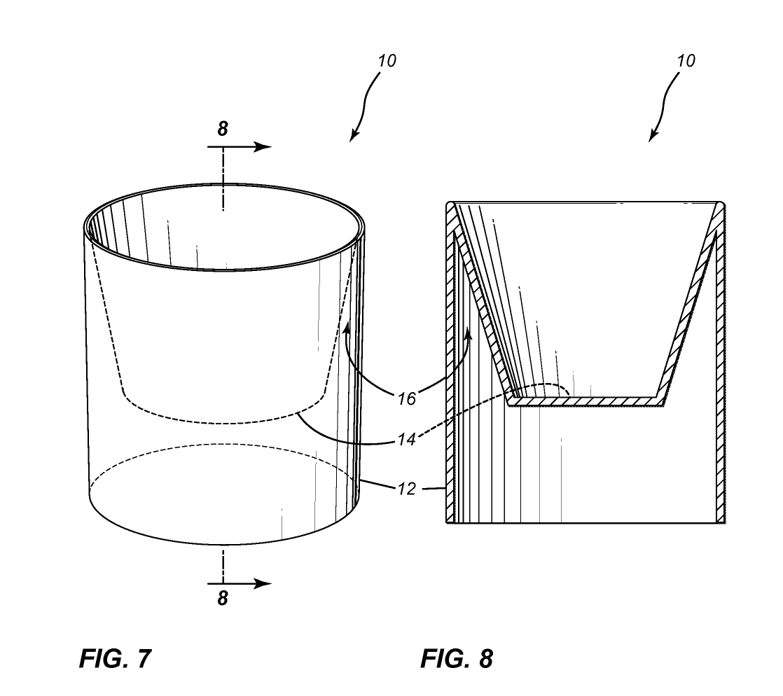

FIGS. 7 and 8 depict a further embodiment of the drinking vessel 10 that has a small frusta-conical cup 14 shaped for shooters. This vessel can be made either squat (as shown) or more elongated.

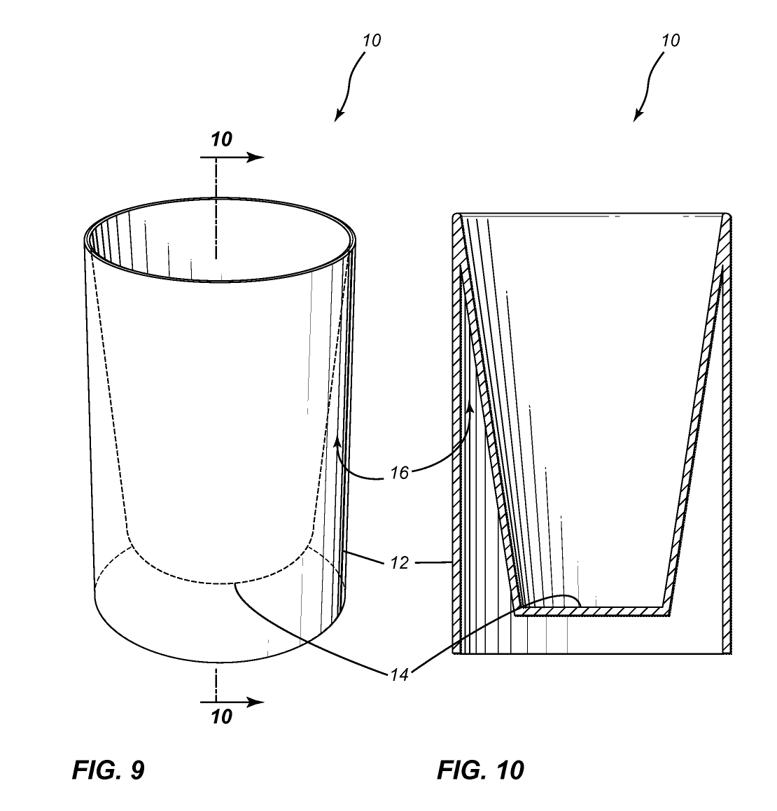

FIGS. 9 and 10 depict yet a further embodiment of the drinking vessel that has a large frusta-conical cup 14 shaped for beer (or other beverages, including non-alcoholic beverages such as soft drinks).

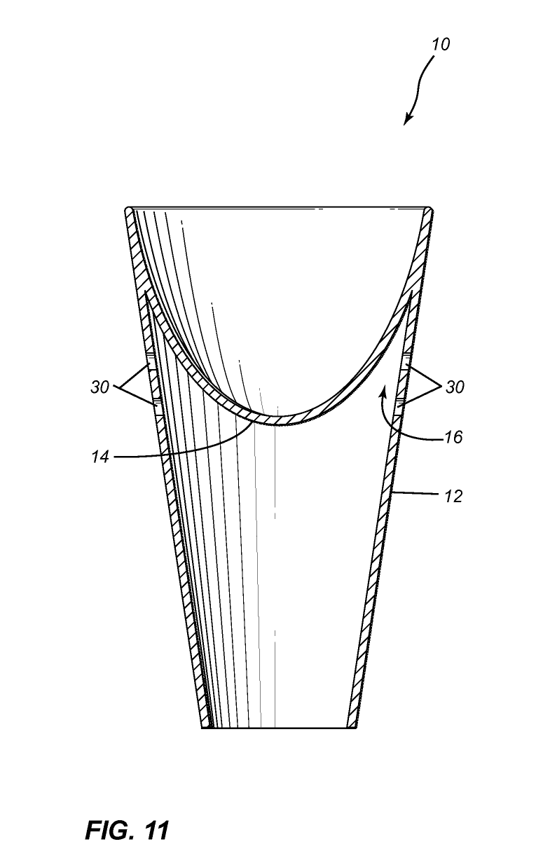

FIG. 11 is a side cross-sectional view of a frusta-conical drinking vessel having air holes 30 in accordance with a further embodiment of the present invention. The air holes are located in the outer shell, to promote dissipation of heat. Although the other embodiments are illustrated without air holes, it should be expressly understood that air holes can be provided in any one of these other embodiments.

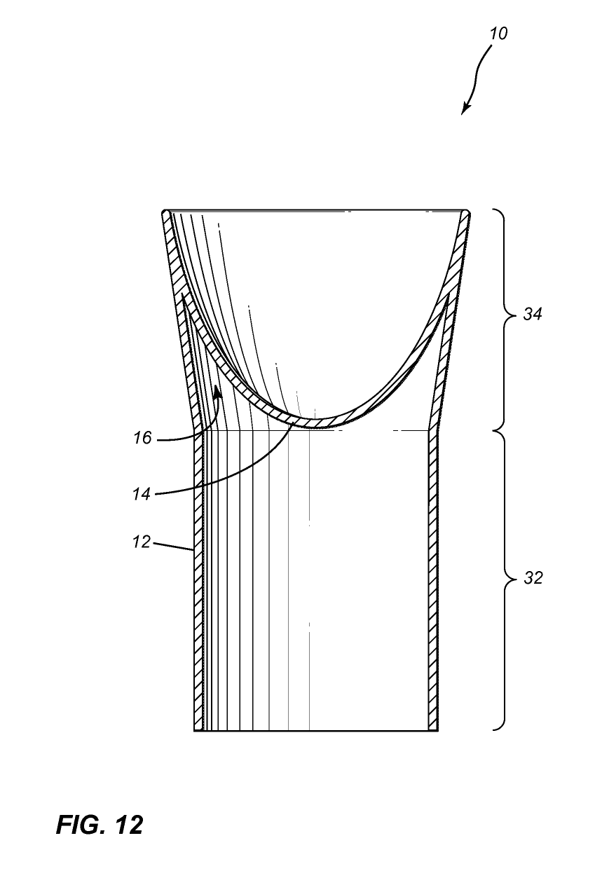

FIG. 12 is a side cross-sectional view of a drinking vessel having a lower cylindrical portion 32 and an upper frusta-conical portion 34 in accordance with yet a further embodiment. Alternatively, the lower portion could be made frusta-conical and the upper portion cylindrical. It should be appreciated that the outer shell could be made with a variety of other shapes, although a cylindrical shape is most preferred because this provides optimal stability, robustness, and ease of manufacture, not to mention an easy surface for placing advertising.

Although the foregoing embodiments are described in terms of drinking vessels, this invention could be modified to be used with other foodstuffs, such as yogurt drinks, yogurt, smoothies, etc. Optionally, the vessel can include a lid, cap or removable foil for hermetically sealing the contents.

The embodiments of the invention described above are intended to be exemplary only. Further variations and refinements can be made to the present invention without departing from the scope of the invention. The scope of the invention is therefore intended to be limited solely by the scope of the appended claims.

1. A drinking vessel comprising:
an outer shell dimensioned to enable a user to ergonomically grasp the drinking vessel; and
a beverage-containing cup mounted inside the outer shell, the cup and outer shell defining an annular air gap to thermally insulate the beverage contained in the cup of the drinking vessel.

2. The drinking vessel as claimed in claim 1 wherein the outer shell is cylindrical.

3. The drinking vessel as claimed in claim 1 wherein the outer shell is slightly frusta-conical.

4. The drinking vessel as claimed in claim 1 wherein the outer shell comprises a cylindrical lower portion and a frusta-conical upper portion.

5. The drinking vessel as claimed in claim 1 wherein the beverage-containing cup has a parabolic shape for containing wine.

6. The drinking vessel as claimed in claim 1 wherein the beverage-containing cup has a fluted shape for containing bubbly wine.

7. The drinking vessel as claimed in claim 1 wherein the beverage-containing cup is V-shaped for a cocktail.

8. The drinking vessel as claimed in claim 1 wherein the beverage-containing cup is a small frusta-conical cup for containing a shooter.

9. The drinking vessel as claimed in claim 1 wherein the beverage-containing cup is a large frusta-conical cup for containing beer.

10. The drinking vessel as claimed in claim 1 wherein the outer shell is dimensioned to fit in a standard cup-holder.

11. The drinking vessel as claimed in claim 1 wherein a top of the beverage-containing cup is aligned with an upper rim of the outer shell.

12. The drinking vessel as claimed in claim 11 wherein the beverage-containing cup has a bottom that is substantially elevated relative to a bottom rim of the outer shell.

13. The drinking vessel as claimed in claim 1 wherein a top of the beverage-containing cup is integrally formed with an upper rim of the outer shell.

14. The drinking vessel as claimed in claim 13 wherein the beverage-containing cup has a bottom that is substantially elevated relative to a bottom rim of the outer shell.

15. The drinking vessel as claimed in claim 1 wherein the outer shell has a bottom rim having a ring for surrounding and reinforcing the bottom rim.

16. The drinking vessel as claimed in claim 1 wherein the outer shell and beverage-containing cup are integrally formed by molding or forming.

17. The drinking vessel as claimed in claim 1 wherein the outer shell and beverage-containing cup are translucent.

18. The drinking vessel as claimed in claim 1 wherein the outer shell and beverage-containing cup are integrally blow-molded from a transparent thermoplastic.

19. The drinking vessel as claimed in claim 1 wherein the outer shell has an outer surface adapted to display advertising or other information.

20. The drinking vessel as claimed in claim 15 wherein the cup, shell and advertising are all translucent to enable the user to view the beverage contained in the cup.

21. The drinking vessel as claimed in claim 1 Wherein the shell comprises a plurality of air holes.

22. The drinking vessel as claimed in claim 2 wherein a top of the beverage-containing cup is aligned with an upper rim of the outer shell.

23. The drinking vessel as claimed in claim 22 wherein the beverage-containing cup has a bottom that is substantially elevated relative to a bottom rim of the outer shell.

24. The drinking vessel as claimed in claim 23 wherein the outer shell and cup are molded or formed to form a unitary disposable plastic drinking vessel.

25. The drinking vessel as claimed in claim 24 wherein the beverage-containing cup has a parabolic shape for containing wine.

26. The drinking vessel as claimed in claim 24 wherein the beverage-containing cup has a parabolic shape for containing bubbly wine.

27. The drinking vessel as claimed in claim 24 wherein the beverage-containing cup is V-shaped for a cocktail.

28. The drinking vessel as claimed in claim 24 wherein the beverage-containing cup is a small frusta-conical cup for containing a shooter.

29. The drinking vessel as claimed in claim 24 wherein the beverage-containing cup is a large frusta-conical cup for containing beer.

30. The drinking vessel as claimed in claim 24 wherein the outer shell and beverage-containing cup are integrally blow-molded from a transparent thermoplastic.

31. The drinking vessel as claimed in claim 24 wherein the beverage-containing cup has a bottom rim having a ring for surrounding and reinforcing the bottom rim.
